(19) United States
(12) Patent Application Publication
(10) Pub. No.: US 2018/0304448 A1
(43) Pub. Date: Oct. 25, 2018

(54) Screw Removal Apparatus

(71) Applicant: Hong Ann Tool Industries Co., Ltd., Taichung City (TW)

(72) Inventor: Cheng-Wei Su, Taichung City (TW)

(21) Appl. No.: 15/878,479

(22) Filed: Jan. 24, 2018

(30) Foreign Application Priority Data
Apr. 20, 2017 (TW) 106113322
Jul. 24, 2017 (TW) 106124787

(51) Int. Cl. B25B 13/48; B25B 23/12; B25B 23/00; B25B 27/00

(52) U.S. Cl. CPC B25B 13/481; B25B 23/12; B25B 21/00; B25B 27/0042; B25B 23/0028

(57) ABSTRACT

A screw removal apparatus includes a shank and a working head connected to the shank. The working head has a base portion and an abutting portion protruding out from the base portion. The shank and the abutting portion extend from the base portion in opposite directions. The abutting portion has a first end, a second end, and an inner periphery extending between the first and second ends in an arc about an axis. The inner periphery has a plurality of ridges and a plurality of recesses. The plurality of ridges and the plurality of recesses alternatively arranged. The base portion and the abutting portion cooperate to form a retaining space for receiving a screw to be removed.

### BACKGROUND OF THE INVENTION

### 1. Field of the Invention

The present invention relates to a screw removal apparatus and, particularly, to a screw removal apparatus adapted to be used in a limited working space, for instance, for removing screws installed on the bottom of an oil tank.

### 2. Description of the Related Art

It is a laborious job to remove a drain screw of an automotive oil tank located on the underside of an automobile because there is a limited working space.

German Pat. DE 202015100755 shows a screw removal tool including a working head configured for engaging with a screw. The working head has a base and two support pieces protruding from the base for retaining a head of a screw engaged therewith. The base includes a magnet inset therein for magnetically attracting the screw head. The two support pieces are in a spaced relationship in order to retain two lateral sides of the screw head. However, if the two support pieces are spaced by a large distance, they are neither unable to retain a small screw head nor can effectively retain a big screw head.

The present invention is, therefore, intended to obviate or at least alleviate the problems encountered in the prior art.

### SUMMARY OF THE INVENTION

A screw removal apparatus adapted for working in a limited working space includes a shank and a working head for engaging with a screw to be removed. The working head is connected to the shank. The working head has a base portion and an abutting portion protruding out from the base portion. The shank and the abutting portion extend from the base portion in opposite directions. The abutting portion has a first end, a second end, and an inner periphery extending between the first and second ends in an arc about an axis. The inner periphery has a plurality of ridges and a plurality of recesses. The plurality of ridges and the plurality of recesses alternatively arranged. The base portion and the abutting portion cooperate to form a retaining space for receiving a screw to be removed.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a screw removal apparatus in accordance with a first embodiment of the present invention.

FIG. 2 is a front view of a working head of the screw removal apparatus shown in FIG. 1.

FIG. 3 is a front view showing the working head of the screw removal apparatus shown in FIG. 1 retaining a small screw head.

FIG. 4 is a front view showing the working head of the screw removal apparatus shown in FIG. 1 retaining a moderate sized screw head.

FIG. 5 is a front view showing the working head of the screw removal apparatus shown in FIG. 1 retaining a big screw head.

FIG. 6 is a perspective view of a screw removal apparatus in accordance with a second embodiment of the present invention.

FIG. 7 is a front view showing a working head of a screw removal apparatus in accordance with a third embodiment of the present invention.

FIG. 8 is a front view showing a working head of a screw removal apparatus in accordance with a fourth embodiment of the present invention.

FIG. 9 is a front view showing the working head of the screw removal apparatus shown in FIG. 8 retaining a moderate sized screw head.

### DETAILED DESCRIPTION OF THE INVENTION

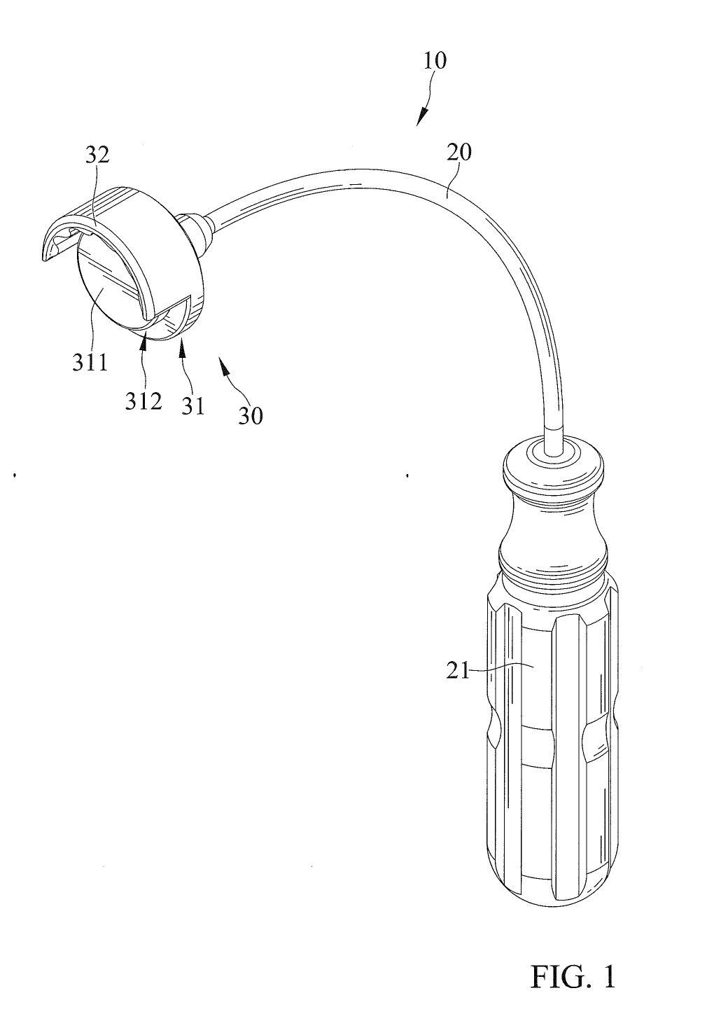

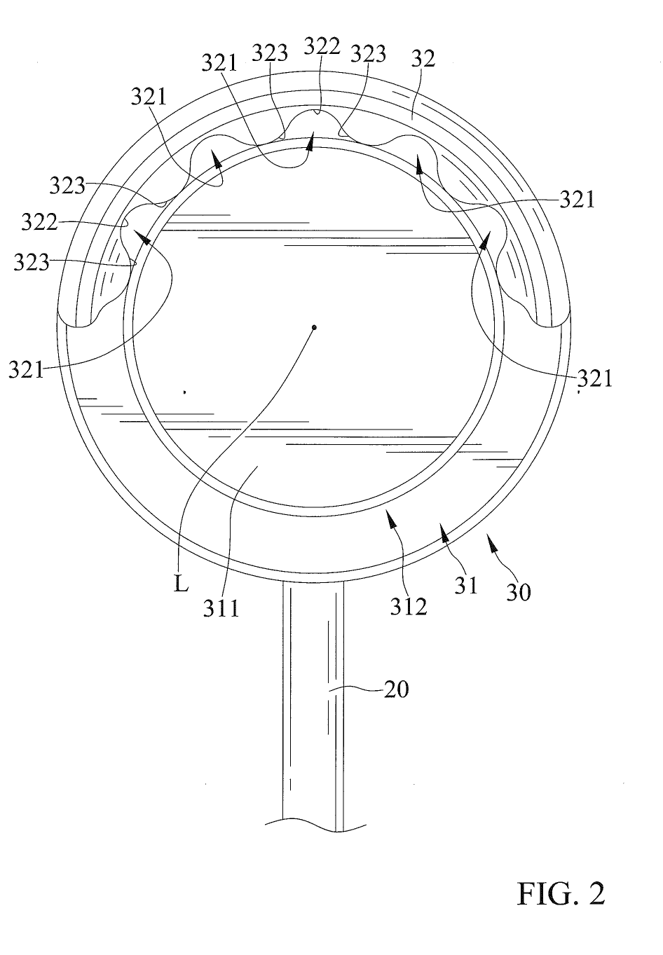

FIGS. 1 through 7 show a screw removal apparatus 10 in accordance with a first embodiment of the present invention. The screw removal apparatus 10 is adapted for working in a limited working space. The screw removal apparatus 10 includes a shank 20 and a working head 30 connected to the shank 20.

The shank 20 is adapted to be gripped and is rotated to rotate the working head 30 about an axis L when operating the screw removal apparatus 10 to remove the screw. The shank 20 is pliable and bendable. The shank 20 includes a handle 21, which is adapted to be gripped ergonomically, connected thereto. The handle 21 and the working head 30 are connected at different ends of the shank 20.

The working head 30 has a base portion 31 and an abutting portion 32 protruding out from the base portion 31. The base portion 31 has a cross-sectional size greater than that of the shank 20. The abutting portion 32 and the shank 20 extend from the base portion 31 in opposite directions. The abutting portion 32 has a first end, a second end, and an inner periphery extending between the first and second ends in an arc about the axis L. The inner periphery having a plurality of ridges and a plurality of recesses 321. The plurality of ridges and the plurality of recesses 321 are alternatively arranged. The plurality of ridges is spaced about the inner periphery of abutting portion 32. The plurality of ridges is parallel to one another. The plurality of ridges is parallel to the axis L. The plurality of ridges is convex. Each of the plurality of ridges has a top surface that is convex. Each of the plurality of ridges has flanks 323 extending divergently from the top surface. Furthermore, the plurality of recesses 321 is spaced about the inner periphery of abutting portion 32. The plurality of recesses 321 is parallel to one another. The plurality of recesses 321 is parallel to the axis L. The plurality of recesses 321 is concave. Each of the plurality of recesses 321 has a bottom surface 322 that is concave.

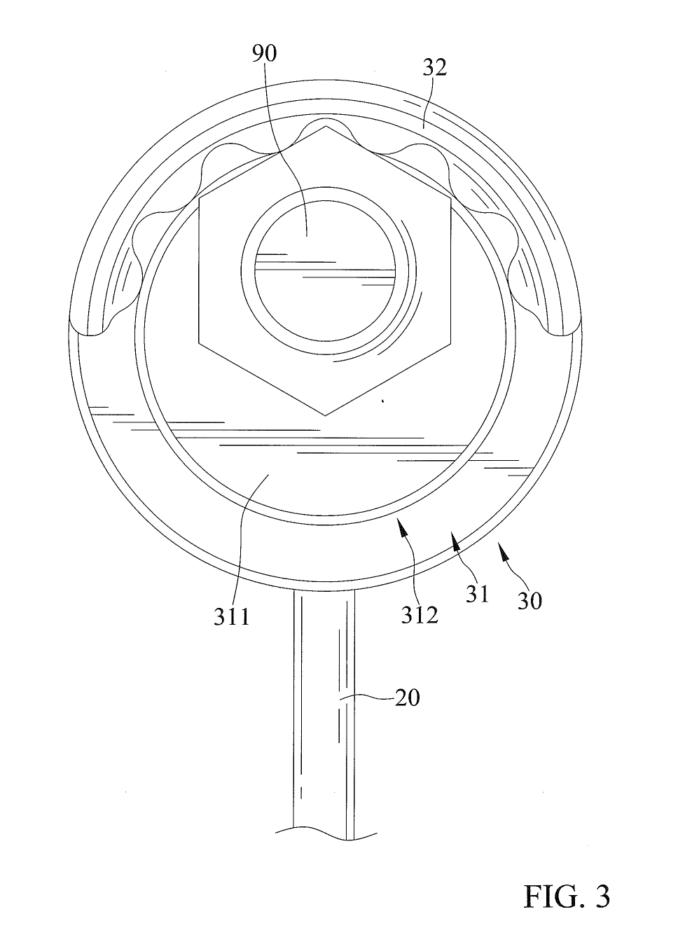

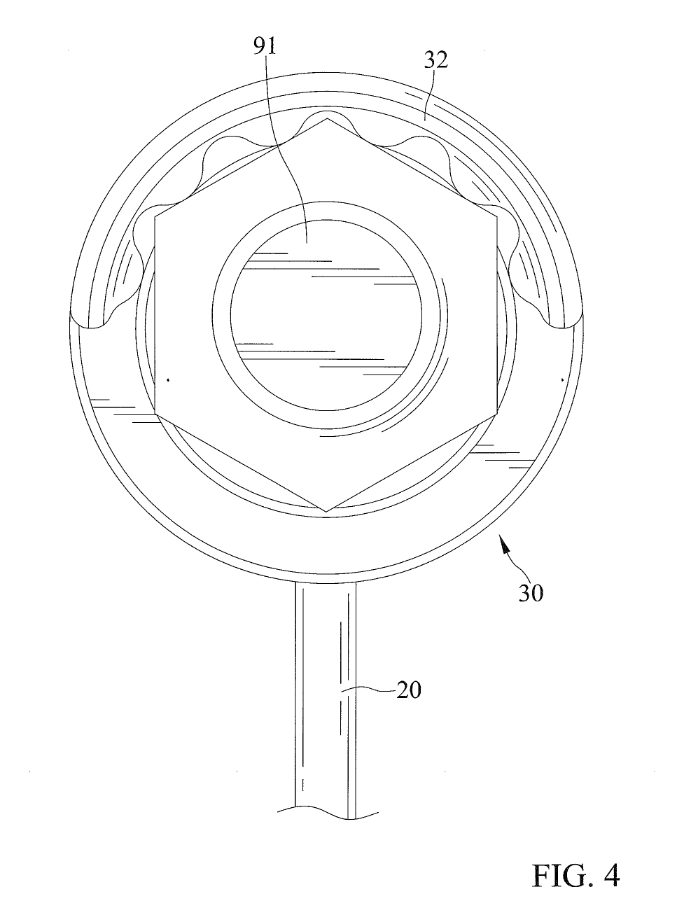

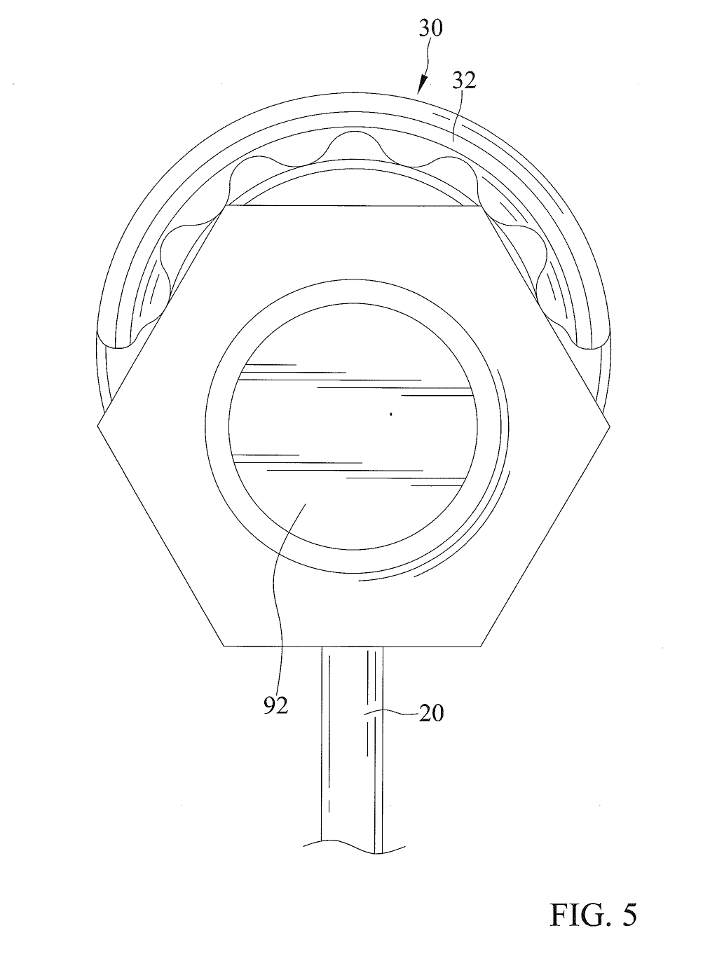

The base portion 31 and the abutting portion 32 cooperate to form a retaining space for receiving a screw to be removed. The retaining space includes an open space between the first and second ends of the abutting portion 32. The inner periphery of the abutting portion 32 and the open space face oppositely. The base portion 31 forms a surface 311 delimiting the retaining space. The surface 311 of the base portion 31 is perpendicular to the axis L. The retaining space is also delimited by the inner periphery of the abutting portion 32. FIG. 3 shows the working head 30 of the screw removal apparatus 10 retaining a small screw head 90. The small screw head 90 is supported by two ridges of abutting portion 32. The two ridges respectively support a lateral side of the small screw head 90. FIG. 4 shows the working head 30 of the screw removal apparatus 10 retaining a moderate sized screw head 91. The moderate sized screw head 91 is supported by four ridges of abutting portion 32. Two of the four ridges respectively support a lateral side of the moderate sized screw head 91. FIG. 5 shows the working head 30 of the screw removal apparatus 10 retaining a big screw head 92. The big screw head 92 is supported by four ridges of abutting portion 32. Two of the four ridges respectively support a lateral side of big screw head 92.

Further, there is a magnetic structure 312 on the working head 30. The magnetic structure 312 is configured for generating a magnetic field for attracting the screw in the retaining space. The magnetic structure 312 is preferably a ferromagnetic material or a ferrimagnetic material. The magnetic structure 312 is on the base portion 31. The surface 311 of the base portion 31 is magnetic.

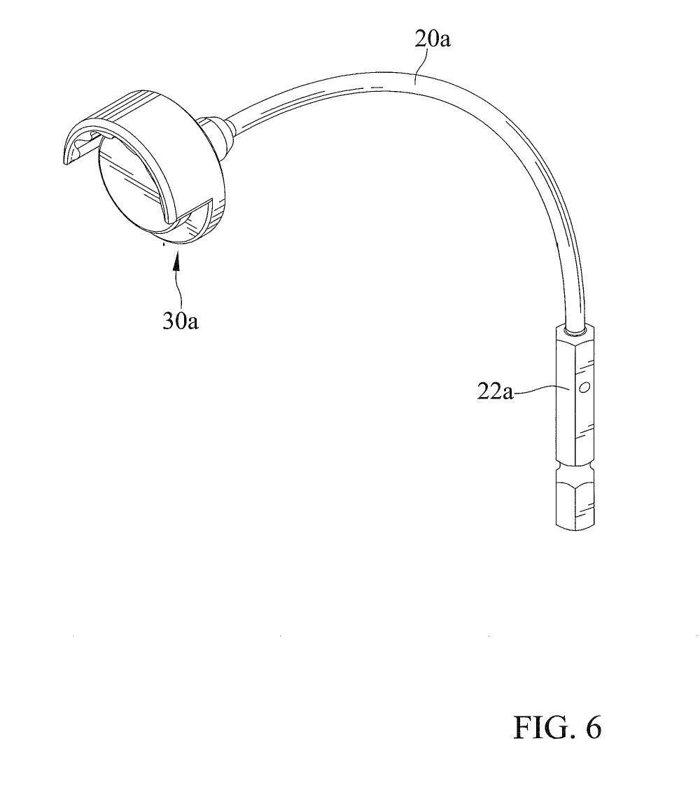

FIG. 6 shows a screw removal apparatus in accordance with a second embodiment of the present invention, and the same numbers are used to correlate similar components of the first embodiment, but bearing a letter a. The screw removal apparatus includes a shank 20a and a working head 30a connected to the shank 20a. The shank 20a is pliable and bendable. The working head 30a has a base portion which forms a surface delimiting the retaining space. Furthermore, the working head has an abutting portion delimiting the retaining space. The abutting portion has an inner periphery delimiting the retaining space. The inner periphery of the abutting portion has a plurality of ridges and a plurality of recesses. The plurality of ridges and the plurality of recesses are alternatively arranged. Each of the plurality of recesses has a bottom surface and flanks extending divergently from the bottom surface 322b. Each of the plurality of ridges has top surface and flanks that extend divergently from the top surface. The second embodiment differentiates from the first embodiment in that the shank 20a includes a driving head 22a, which is connectible to a power tool, connected thereto. The driving head 22a has a polygonal cross section. In the embodiment, the driving head 22 has a hexagonal cross section. The driving head 22a and the working head 30a are connected at different ends of the shank 20a.

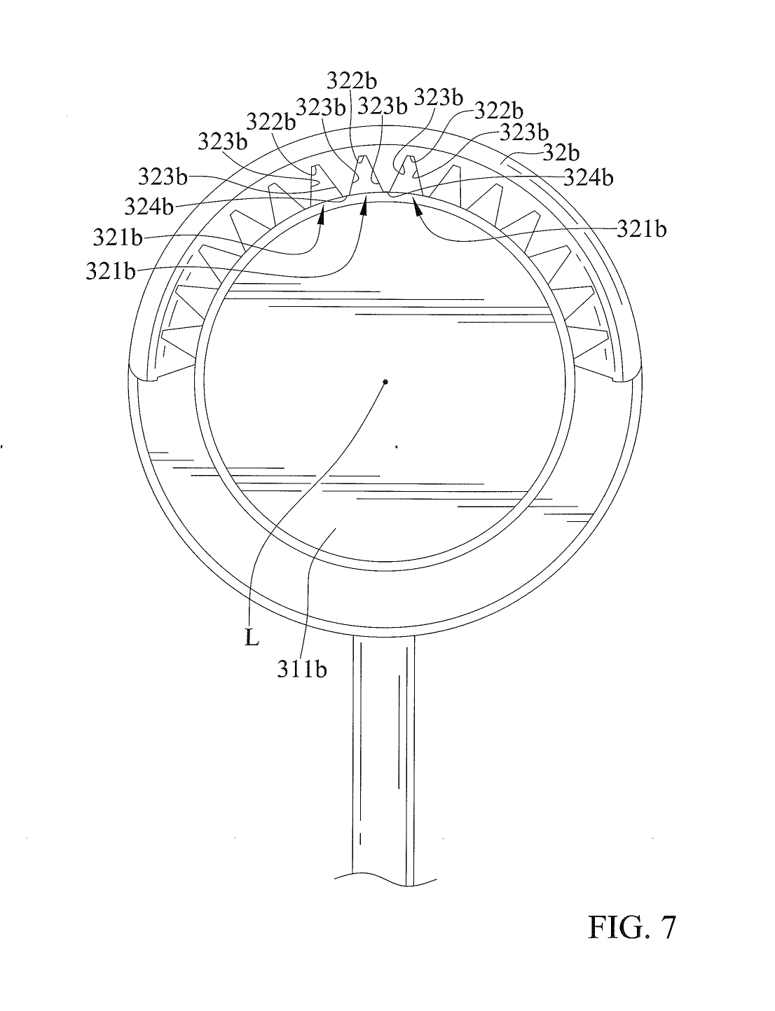

FIG. 7 shows a screw removal apparatus in accordance with a third embodiment of the present invention, and the same numbers are used to correlate similar components of the first embodiment, but bearing a letter b. The screw removal apparatus includes a shank and a working head connected to the shank. The shank is pliable and bendable. There is a magnetic structure on the working head. The working head has a base portion which forms a surface 311b delimiting the retaining space. Furthermore, the working head has an abutting portion 32b delimiting the retaining space. The abutting portion 32b has an inner periphery delimiting the retaining space. The inner periphery of the abutting portion 32b has a plurality of ridges and a plurality of recesses 321b. The plurality of ridges and the plurality of recesses 321b are alternatively arranged. Each of the plurality of recesses 321b has a bottom surface 322b and flanks 323b extending divergently from the bottom surface 322b. Each of the plurality of ridges has top surface 324b and flanks that extend divergently from the top surface 324b. The third embodiment differentiates from the first embodiment in that the flanks 323b are located on two planes inclined with respect to one another at an angle greater than 35 degrees and less than 40 degrees.

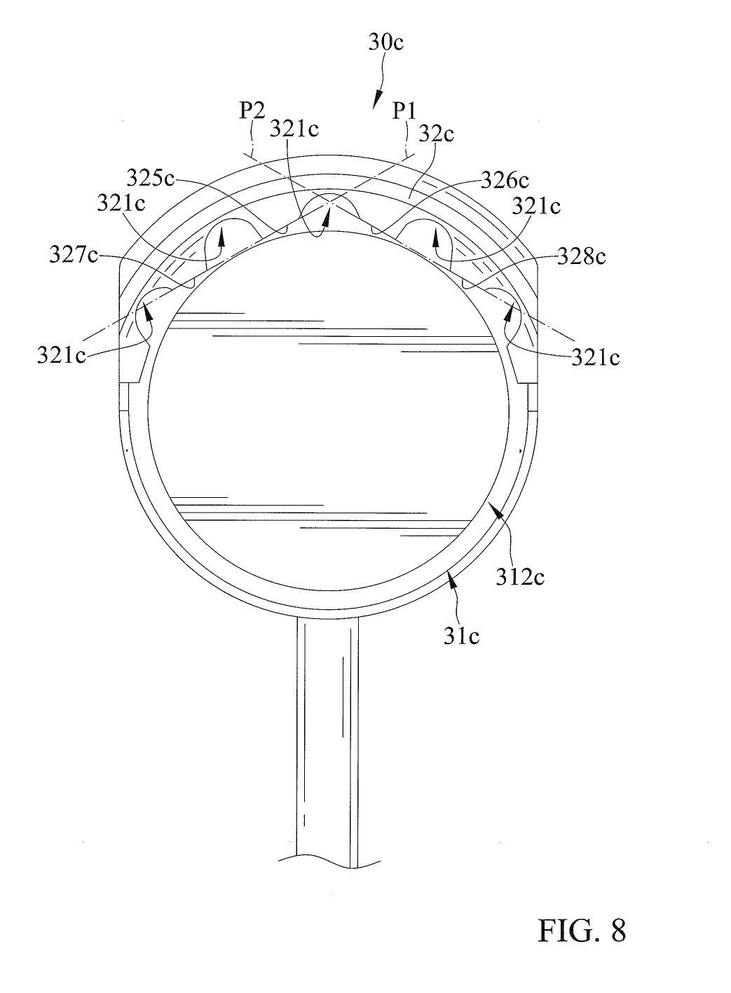

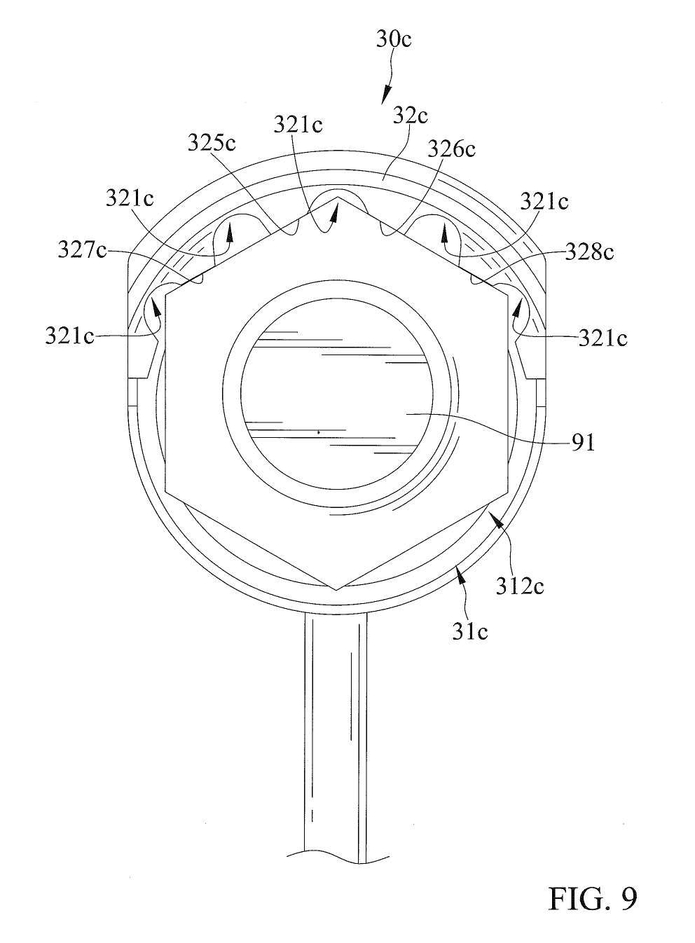

FIGS. 8 and 9 show a screw removal apparatus in accordance with a fourth embodiment of the present invention, and the same numbers are used to correlate similar components of the first embodiment, but bearing a letter c. The screw removal apparatus includes a shank and a working head 30c connected to the shank. The shank is pliable and bendable. There is a magnetic structure on the working head 30c. The working head 30c has a base portion 31c which forms a surface delimiting the retaining space. Furthermore, the working head 30c has an abutting portion 32c delimiting the retaining space. The abutting portion 32c has an inner periphery delimiting the retaining space. The inner periphery of the abutting portion 32c has a plurality of ridges and a plurality of recesses 321c. The plurality of ridges and the plurality of recesses 321c are alternatively arranged. Each of the plurality of recesses 321c has a bottom surface and flanks extending divergently from the bottom surface. Each of the plurality of ridges has top surface and flanks that extend divergently from the top surface. The plurality of ridges includes first and second ridges adjoining opposite flanks of a first of the plurality of recesses 321c. The plurality of ridges includes a third ridge located adjacent to the first ridge and a fourth ridge located adjacent to the second ridge respectively. The first and third ridges respectively form first and third retaining surfaces 325c and 327c. The second and fourth ridges respectively form second and fourth retaining surfaces 326c and 328c. The fourth embodiment differentiates from the first embodiment in that the first and third retaining surfaces 325c and 327c are located on a first plane P1 and the second and fourth retaining surfaces 326c and 328c are located on a second plane P2. The first and second planes P1 and P2 are intersected near the first recess 321c and the first plane P1 is inclined with respect to the second plane at an angle of 120 degrees. Furthermore, the first and third retaining surfaces 325c and 327c) are sloped. The second and fourth retaining surfaces 326c and 328c are sloped. In addition, FIG. 9 shows the working head 30c of the screw removal apparatus retaining a moderate sized screw head 91. The moderate sized screw head 91 is supported by the first, second, third, and fourth retaining surfaces 325c, 326c, 327c, and 328c of the abutting portion 32c. The first and third retaining surfaces 325c and 327c support one lateral side of the moderate sized screw head 91. The second and fourth retaining surfaces 326c and 328c support another lateral side of the of the moderate sized screw head 91.

In view of the foregoing, each of the working heads 30, 30a, and 30c can keep a screw to be removed in the respective retaining space, no matter what size the screw may be, because the working heads 30, 30a, and 30c include at least two ridges of the respective abutting portion 32, 32b, and 32c for keeping a screw to be removed in the retaining space. Furthermore, the screw can be magnetically kept in the retaining space by the magnetic structures 312 and 312c.

The foregoing is merely illustrative of the principles of this invention, and various modifications can be made by those skilled in the art without departing from the scope and spirit of the invention.

What is claimed is:

1. A screw removal apparatus adapted for working in a limited working space comprising:
a shank; and
a working head connected to the shank, wherein the working head has a base portion and an abutting portion protruding out from the base portion, with the shank and the abutting portion extending from the base portion in opposite directions, with the abutting portion having a first end, a second end, and an inner periphery extending between the first and second ends in an arc about an axis, with the inner periphery having a plurality of ridges and a plurality of recesses, and with the plurality of ridges and the plurality of recesses alternatively arranged;
wherein the base portion and the abutting portion cooperate to form a retaining space for receiving a screw to be removed.

2. The screw removal apparatus as claimed in claim 1, wherein the retaining space includes an open space between the first and second ends of the abutting portion, and wherein the inner periphery of the abutting portion and the open space face oppositely.

3. The screw removal apparatus as claimed in claim 1, wherein the plurality of ridges is spaced about the inner periphery of abutting portion, and wherein the plurality of recesses is spaced about the inner periphery of abutting portion.

4. The screw removal apparatus as claimed in claim 3, wherein the plurality of ridges is parallel to one another, wherein the plurality of ridges is parallel to the axis wherein the plurality of recesses is parallel to one another, and wherein the plurality of recesses is parallel to the axis.

5. The screw removal apparatus as claimed in claim 2, wherein the plurality of ridges is spaced about the inner periphery of abutting portion, and wherein the plurality of recesses is spaced about the inner periphery of abutting portion.

6. The screw removal apparatus as claimed in claim 5, wherein the plurality of ridges is convex, and wherein the plurality of recesses is concave.

7. The screw removal apparatus as claimed in claim 5, wherein each of the plurality of recesses has a bottom surface and flanks extending divergently from the bottom surface, and wherein the flanks are located on two planes inclined with respect to one another at an angle greater than 35 degrees and less than 40 degrees.

8. The screw removal apparatus as claimed in claim 5, wherein the plurality of ridges includes first and second ridges adjoining opposite flanks of a first of the plurality of recesses, wherein the plurality of ridges includes a third ridge located adjacent to the first ridge and a fourth ridge located adjacent to the second ridge respectively, wherein the first and third ridges respectively form first and third retaining surfaces and the first and third retaining surfaces are located on a first plane, wherein the second and fourth ridges respectively form second and fourth retaining surfaces and the second and fourth retaining surfaces are located on a second plane, and wherein the first and second planes are intersected near the first recess and the first plane is inclined with respect to the second plane at an angle of 120 degrees.

9. The screw removal apparatus as claimed in claim 8, wherein the first and third retaining surfaces are sloped, and wherein the second and fourth retaining surfaces are sloped.

10. The screw removal apparatus as claimed in claim 1 further comprising a magnetic structure on the working head, and wherein the magnetic structure is configured for generating a magnetic field for attracting the screw in the retaining space.

11. The screw removal apparatus as claimed in claim 10 wherein the magnetic structure is on the base portion.

12. The screw removal apparatus as claimed in claim 5 further comprising a magnetic structure on the working head, and wherein the magnetic structure is configured for generating a magnetic field for attracting the screw in the retaining space.

13. The screw removal apparatus as claimed in claim 1, wherein the shank is pliable and bendable.

14. The screw removal apparatus as claimed in claim 13, wherein the shank has a cross-sectional size smaller than a cross-sectional size of the base portion.

15. The screw removal apparatus as claimed in claim 5, wherein the shank is pliable and bendable.

16. The screw removal apparatus as claimed in claim 15, wherein the shank includes a handle, which is adapted to be gripped ergonomically, connected thereto.

17. The screw removal apparatus as claimed in claim 15, wherein the shank includes a driving head, which is connectible to a power tool, connected thereto.

18. The screw removal apparatus as claimed in claim 4, wherein the retaining space includes an open space between the first and second ends of the abutting portion, and wherein the inner periphery of the abutting portion and the open space face oppositely.

19. The screw removal apparatus as claimed in claim 18 further comprising a magnetic structure on the working head, and wherein the magnetic structure is configured for generating a magnetic field for attracting the screw in the retaining space.

20. The screw removal apparatus as claimed in claim 19, wherein the shank is pliable and bendable.
